(19) United States
(12) Patent Application Publication
(10) Pub. No.: US 2016/0112820 A1
(43) Pub. Date: Apr. 21, 2016

(54) VIRTUAL SOUND IMAGE LOCALIZATION METHOD FOR TWO DIMENSIONAL AND THREE DIMENSIONAL SPACES

(71) Applicant: ELECTRONICS AND TELECOMMUNICATIONS RESEARCH INSTITUTE, Yuseong-gu Daejeon (KR)

(72) Inventors: Jae Hyoun YOO, Daejeon (KR); Yong Ju LEE, Daejeon (KR); Jeong Il SEO, Daejeon (KR); Kyeong Ok KANG, Daejeon (KR); Keun Woo CHOI, Daejeon (KR); Hee Suk PANG, Daejeon (KR)

(73) Assignee: Electronics and Telecommunications Research Institute, Yuseong-gu, Daejeon (KR)

(21) Appl. No.: 14/758,719

(22) PCT Filed: Jul. 7, 2014
(86) PCT No.: PCT/KR2014/006053

§ 371 Date: Jun. 30, 2015

(30) Foreign Application Priority Data
Jul. 5, 2013 (KR) 10-2013-0079116
Jul. 5, 2013 (KR) 10-2013-0079263
Jul. 4, 2014 (KR) 10-2014-0083959

(51) Int. Cl. H04S 7/00

(52) U.S. Cl. CPC H04S 7/302; H04S 2400/11

(57) ABSTRACT

A virtual sound image localization method in a two-dimensional (2D) space and three-dimensional (3D) space is provided. The virtual sound image localization method may include setting a reproduction region including at least one loudspeaker available in an output channel; dividing the reproduction region into a plurality of sub-regions; determining a sub-region in which a virtual sound source to be reproduced is located among the sub-regions; determining a panning coefficient used to reproduce the virtual sound source, based on the determined sub-region; and rendering an input signal based on the panning coefficient.

### TECHNICAL FIELD

The following embodiments relate to a virtual sound image localization method using a plurality of loudspeakers corresponding to an output channel.

### BACKGROUND ART

A panning scheme refers to a scheme of reproducing a virtual sound source by allocating power to a loudspeaker located around the virtual sound source, based on a location of the virtual sound source. Determining of a location of a virtual sound source in a virtual space by allocating power to a loudspeaker and by determining an output magnitude of the loudspeaker is referred to as a virtual sound image localization method.

Reproducing of a virtual sound source using two loudspeakers may be defined as power panning, and reproducing of a virtual sound source using three loudspeakers may be defined as vector based amplitude panning (VBAP). The above technologies are being widely utilized as a virtual sound image localization method.

The above-described schemes may use an operation of distributing power to loudspeakers in order to map a location of a virtual sound source between two or three loudspeakers. In the operation, an elaborate angle division is possible, however, it may be difficult for a listener to identify a virtual sound source located at a divided angle, and an amount of computation may increase. Additionally, when a number of an input channel panned to a loudspeaker corresponding to an output channel increases, a sound quality may be degraded. Accordingly, a panning scheme for solving an issue caused by angle division is required.

Loudspeakers may typically be disposed in a reproduction space, to be symmetrical to each other in a right side and a left side of a listener. However, the above symmetrical arrangement is an ideal situation in real life. Actually, loudspeakers are often disposed in an asymmetrical array. Accordingly, a panning scheme for asymmetrically arranged loudspeakers is also required.

### DISCLOSURE OF INVENTION

### Technical Goals

The following embodiments provide a virtual sound image localization method using loudspeakers in a two-dimensional (2D) space and a three-dimensional (3D) space, and a loudspeaker renderer for performing the virtual sound image localization method.

The following embodiments provide a virtual sound image localization method for dividing a reproduction region including loudspeakers into sub-regions, and for determining a panning coefficient based on a sub-region in which a virtual sound source to be reproduced is located, to reduce an amount of computation to determine the panning coefficient, and provide a loudspeaker renderer for performing the virtual sound image localization method.

The following embodiments provide a virtual sound image localization method for effectively reproducing a virtual sound source by determining a panning coefficient based on whether loudspeakers are located in a 2D space or 3D space, and provide a loudspeaker renderer for performing the virtual sound image localization method.

### Technical Solutions

According to an aspect of the present invention, there is provided a virtual sound image localization method including: determining reproduction information on at least one loudspeaker available in an output channel to reproduce a virtual sound source corresponding to an input channel; and rendering an input signal based on the reproduction information.

The loudspeaker may exist in a two-dimensional (2D) space or three-dimensional (3D) space.

The determining may include dividing a reproduction region including the loudspeaker into a plurality of sub-regions, determining a sub-region in which the virtual sound source is located among the sub-regions, and determining a panning coefficient of the loudspeaker based on the determined sub-region.

The dividing may include dividing a reproduction region corresponding to a circumference connecting two loudspeakers into a plurality of sub-regions. The determining may include determining a sub-region in which the virtual sound source is located among the sub-regions.

The dividing may include dividing a reproduction region including K loudspeakers (K>3) into X sub-regions (X≧K). The determining may include determining a sub-region in which the virtual sound source is located among the sub-regions.

According to another aspect of the present invention, there is provided a virtual sound image localization method including: setting a reproduction region including at least one loudspeaker available in an output channel; dividing the reproduction region into a plurality of sub-regions; determining a sub-region in which a virtual sound source to be reproduced is located among the sub-regions; determining a panning coefficient used to reproduce the virtual sound source, based on the determined sub-region; and rendering an input signal based on the panning coefficient.

The loudspeaker may exist in a 2D space or 3D space.

The dividing may include dividing a reproduction region corresponding to a circumference connecting two loudspeakers into a plurality of sub-regions. The determining may include determining a sub-region in which the virtual sound source is located among the sub-regions.

The dividing may include dividing a reproduction region including K loudspeakers (K>3) into X sub-regions (X≧K). The determining may include determining a sub-region in which the virtual sound source is located among the sub-regions.

According to another aspect of the present invention, there is provided a virtual sound image localization method including: determining whether determining of a panning coefficient for a virtual sound source based on loudspeakers located on a plane is possible; and determining the panning coefficient based on a result of the determining.

The determining of the panning coefficient may include, when the determining of the panning coefficient based on the loudspeaker on the plane is possible, determining the panning coefficient based on a horizontal angle.

The determining of the panning coefficient may include, when the determining of the panning coefficient based on the loudspeaker on the plane is impossible, determining the panning coefficient based on a vertical angle.

According to another aspect of the present invention, there is provided a virtual sound image localization method including: determining whether loudspeakers are located in a 2D space or 3D space; and determining a panning coefficient for a virtual sound source, based on a result of the determining

The determining of the panning coefficient may include, when the loudspeakers are located in the 2D space, determining the panning coefficient based on a horizontal angle.

The determining of the panning coefficient may include, when the loudspeakers are located in the 3D space, determining the panning coefficient based on a vertical angle.

According to another aspect of the present invention, there is provided a loudspeaker renderer including: a determining unit to determine reproduction information on at least one loudspeaker available in an output channel to reproduce a virtual sound source corresponding to an input channel; and a rendering unit to render an input signal based on the reproduction information.

According to another aspect of the present invention, there is provided a loudspeaker renderer including: a determining unit to determine a panning coefficient used to reproduce a virtual sound source, based on sub-regions into which a reproduction region including at least one loudspeaker available in an output channel is divided; and a rendering unit to render an input signal based on the panning coefficient.

According to another aspect of the present invention, there is provided a loudspeaker renderer including: a determining unit to determine whether determining of a panning coefficient for a virtual sound source based on loudspeakers located on a plane is possible, and to determine the panning coefficient based on a result of the determining; and a rendering unit to render an input signal based on the panning coefficient.

According to another aspect of the present invention, there is provided a loudspeaker renderer including: a determining unit to determine whether loudspeakers are located in a 2D space or 3D space, and to determine a panning coefficient for a virtual sound source based on a result of the determining; and a rendering unit to render an input signal based on the panning coefficient.

When the loudspeakers are located in the 2D space, the determining unit may determine the panning coefficient based on a horizontal angle. When the loudspeakers are located in the 3D space, the determining unit may determine the panning coefficient based on a vertical angle.

### Effect of the Invention

According to embodiments, a reproduction region including loudspeakers may be divided into sub-regions, and a panning coefficient may be determined based on a sub-region in which a virtual sound source to be reproduced is located and thus, it is possible to reduce an amount of computation for determining the panning coefficient.

Additionally, according to embodiments, a panning coefficient may be determined based on whether loudspeakers are located in a two-dimensional (2D) space or three-dimensional (3D) space and thus, it is possible to effectively reproduce a virtual sound source.

### BRIEF DESCRIPTION OF DRAWINGS

FIG. 1 illustrates a loudspeaker renderer for performing a virtual sound image localization method according to an embodiment.

FIG. 2 illustrates an example of a virtual sound image localization method according to an embodiment.

FIG. 3 illustrates another example of a virtual sound image localization method according to an embodiment.

FIG. 4 illustrates an example of a space grouping-based panning scheme according to an embodiment.

FIG. 5 illustrates the space grouping-based panning scheme of FIG. 4 in an example in which K is set to “3.”

FIG. 6 illustrates another example of a space grouping-based panning scheme according to an embodiment.

FIG. 7 illustrates the space grouping-based panning scheme of FIG. 6 in an example in which K is set to “4.”

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

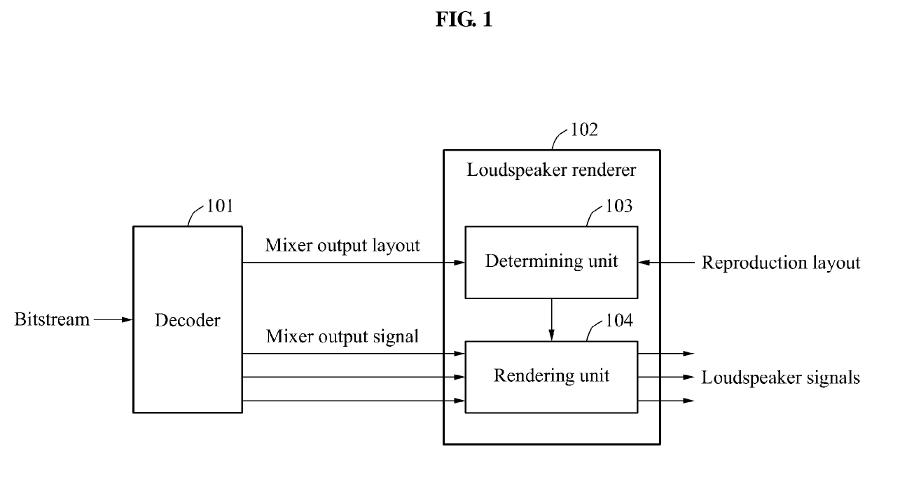

FIG. 1 illustrates a loudspeaker renderer for performing a virtual sound image localization method according to an embodiment.

Referring to FIG. 1, a loudspeaker renderer 102 may include a determining unit 103, and a rendering unit 104.

The determining unit 103 may receive a mixer output layout from a decoder 101. The mixer output layout may refer to a format of a mixer output signal output from the decoder 101 by decoding a bitstream. For the loudspeaker renderer 102, the mixer output signal may be an input signal, and the mixer output layout may be an input format.

The determining unit 103 may determine reproduction information associated with a plurality of loudspeakers, based on the mixer output layout and a reproduction layout. The reproduction information may refer to information used to convert an input format representing the mixer output layout to an output format representing the reproduction layout. Accordingly, the loudspeaker renderer 102 may be expressed as a format converter.

For example, when the number of channel related to an input format is greater than the number of channel related to an output format, the reproduction information may include a downmix matrix used to map an input signal to an output signal. The loudspeaker renderer 102 may convert an M-channel input signal to an N-channel output signal corresponding to a reproduction layout that needs to be used for reproduction. The determining unit 103 may determine reproduction information for format conversion.

In this example, an input signal corresponding to a mono channel may be mapped to an output signal corresponding to a mono channel or a plurality of channels, based on a loudspeaker. In other words, input signals may be mapped to an output signal corresponding to a mono channel. Additionally, an input signal may be panned to an output signal corresponding to a stereo channel. Furthermore, an input signal may be distributed as an output signal corresponding to at least three channels.

The determining unit 103 may determine reproduction information used to map an input signal to an output signal corresponding to a mono channel or a plurality of channels. The determined reproduction information may include a downmix matrix including a plurality of panning coefficients.

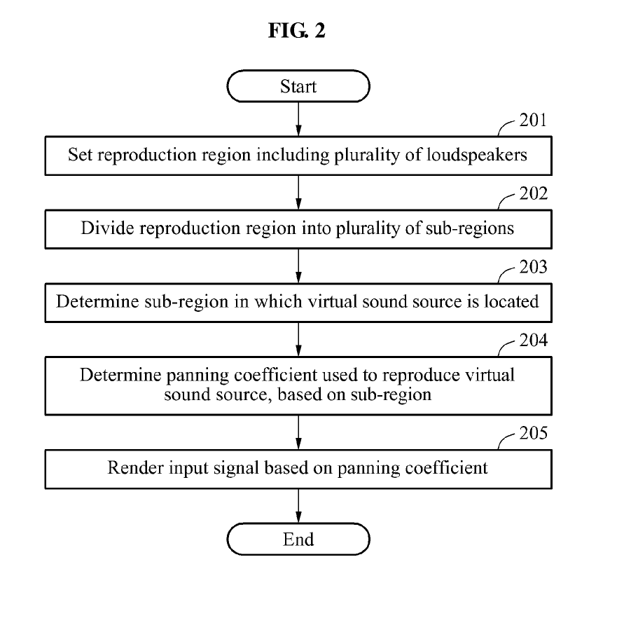

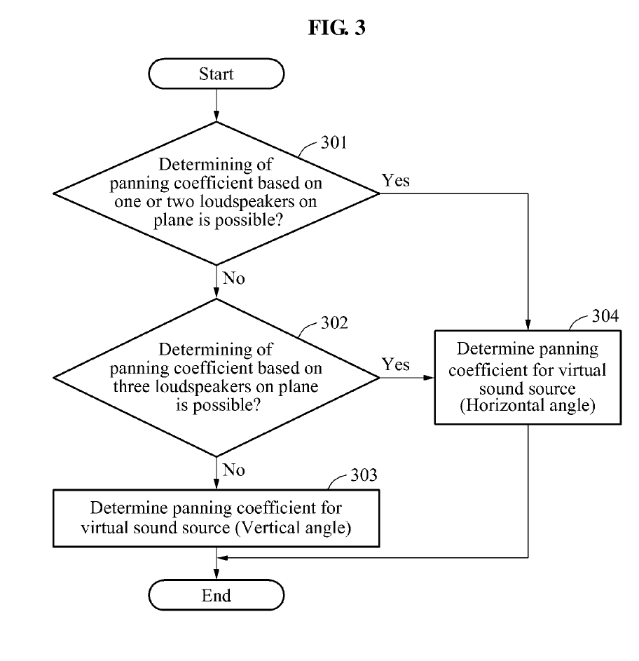

Hereinafter, a process of determining reproduction information so that a sound source corresponding to an input signal is reproduced using a loudspeaker when the input signal is mapped to an output signal will be described below. For example, the determining unit 103 may determine a panning coefficient for virtual sound image localization, by controlling power input to the loudspeakers. The virtual sound image localization may provide a listener with an effect of reproducing a virtual sound source, instead of a real sound source, in a virtual space between loudspeakers. An operation of determining a panning coefficient will be further described with reference to FIGS. 2 and 3.

The rendering unit 104 may render the mixer output signal received from the decoder 101 by mapping the mixer output signal to a loudspeaker signal, based on the reproduction information. In other words, the rendering unit 104 may map an input signal corresponding to an input format to an output signal corresponding to an output format, and may render the input signal. For example, the rendering unit 104 may map the input signal to the output signal, based on the panning coefficient determined by the determining unit 103, and may render the input signal.

FIG. 2 illustrates an example of a virtual sound image localization method according to an embodiment.

In operation 201, the loudspeaker renderer 102 may set a reproduction region including a plurality of loudspeakers. The reproduction region may refer to, for example, a line connecting two loudspeakers, or a plane including at least three loudspeakers. The line may include, for example, a straight line or a curve (circumference).

For example, a virtual sound source corresponding to an input signal may be assumed to be reproduced in the reproduction region, instead of in a location in which a loudspeaker is located. The reproduction region may refer to a virtual two-dimensional (2D) space or three-dimensional (3D) space including the plurality of loudspeakers, and may refer to a location in which the virtual sound source is reproduced.

In operation 202, the loudspeaker renderer 102 may divide the reproduction region into a plurality of sub-regions. The reproduction region may be divided into K sub-regions. The sub-regions may be identical to, or different from each other.

In operation 203, the loudspeaker renderer 102 may determine a sub-region in which the virtual sound source is located. As described above, the reproduction region may refer to a location in which the virtual sound source is reproduced and accordingly, the loudspeaker renderer 102 may determine one of the sub-regions in which the virtual sound source is to be reproduced.

In operation 204, the loudspeaker renderer 102 may determine a panning coefficient used to reproduce the virtual sound source, based on the sub-region. The panning coefficient may be determined to have a value of “−1” to “1.”

In operation 205, the loudspeaker renderer 102 may render the input signal, based on the panning coefficient.

The virtual sound image localization method of FIG. 2 may be defined as a division-based panning scheme, because a result obtained by dividing a reproduction region into the sub-regions may be used.

Hereinafter, a process of converting a format of an input signal with multiple channels will be described based on the virtual sound image localization method of FIG. 2. The process of converting a format of an input signal may refer to a process of rendering the input signal by mapping the input signal to an output signal.

To reproduce a sound source corresponding to an M-channel input signal using an N-channel loudspeaker (M>2, N>2), the M-channel input signal may need to be converted to an N-channel output signal, based on Equation 1 as shown below.

Y=AX [Equation 1]

In Equation 1, Y denotes an output signal reproduced through a loudspeaker corresponding to an n channel (n=1˜N), and may be expressed as shown in Equation 2 below.

$$Y = [ \begin{matrix}{y}_{1} \\ {y}_{2} \\ ⋮ \\ {y}_{N}\end{matrix} ] \qquad [ Equation 2 ]$$

In addition, X denotes an input signal corresponding to an m channel (m=1˜M), and may be expressed as shown in Equation 3 below.

$$X = [ \begin{matrix}{x}_{1} \\ {x}_{2} \\ ⋮ \\ {x}_{M}\end{matrix} ] \qquad [ Equation 3 ]$$

Furthermore, A denotes an N×M matrix including a panning coefficient described with reference to FIG. 2, and may be expressed as shown in Equation 4 below.

$$A = [ \begin{matrix}{a}_{11} & {a}_{12} & … & {a}_{1 M} \\ {a}_{21} & {a}_{22} & … & {a}_{2 M} \\ ⋮ & ⋮ & … & ⋮ \\ {a}_{N 1} & {a}_{N 2} & … & {a}_{NM}\end{matrix} ] \qquad [ Equation 4 ]$$

Equation 1 may be expressed again by Equation 5 as shown below.

$${y}_{n} = {\sum }_{m = 1}^{M} {a}_{nm} {x}_{m} = {a}_{n 1} {x}_{1} + {a}_{n 2} {x}_{2} + … + {a}_{nM} {x}_{M} \\ ( n = 1 , 2 , … , N ) \qquad [ Equation 5 ]$$

Equation 5 may be briefly expressed by Equation 6 as shown below.

n=aₙ₁1+aₙ₂2+ . . . +a_{nM} for n=1, 2, . . . , N [Equation 6]

When the M-channel input signal is assumed to correspond to a 22.2 channel, a 14.0 channel, an 11.1 channel, and a 9.0 channel, only a channel indicated by X may be actually included based on a format of each channel, as shown in Table 1 below.

TABLE 1

| | Horizontal | Vertical | Input channel format | | | |
|---|---|---|---|---|---|---|
| No. | angle° | angle° | 14.0 | 9.0 | 11.1 | 22.2 |
| 1 | 0 | 0 | X | X | X | X |
| 2 | 30 | 0 | X | X | X | X |
| 3 | −30 | 0 | X | X | X | X |
| 4 | 60 | 0 | | | | X |
| 5 | −60 | 0 | | | | X |
| 6 | 90 | 0 | | | | X |
| 7 | −90 | 0 | | | | X |
| 8 | 110 | 0 | | X | X | |
| 9 | −110 | 0 | | X | X | |
| 10 | 135 | 0 | X | | | X |
| 11 | −135 | 0 | X | | | X |
| 12 | 180 | 0 | | | | X |
| 13 | 0 | 35 | X | | X | X |
| 14 | 45 | 35 | X | | | X |
| 15 | −45 | 35 | X | | | X |
| 16 | 30 | 35 | | X | X | |
| 17 | −30 | 35 | | X | X | |
| 18 | 90 | 35 | X | | | X |
| 19 | −90 | 35 | X | | | X |
| 20 | 110 | 35 | | X | X | |
| 21 | −110 | 35 | | X | X | |
| 22 | 135 | 35 | X | | | X |
| 23 | −135 | 35 | X | | | X |
| 24 | 180 | 35 | X | | | X |
| 25 | 0 | 90 | X | | X | X |
| 26 | 0 | −15 | | | | X |
| 27 | 45 | −15 | | | | X |
| 28 | −45 | −15 | | | | X |
| 29(LFE1) | 45 | −15 | | | X | X |
| 30(LFE2) | −45 | −15 | | | | X |

Additionally, when the N-channel output signal is assumed to correspond to a 5.1 channel, an 8.1 channel, and a 10.1 channel, only a channel indicated by X may be actually included based on a format of each channel, as shown in Table 2 below.

TABLE 2

| | Horizontal | Vertical | Output channel format | | |
|---|---|---|---|---|---|
| No. | angle° | angle° | 5.1 | 8.1 | 10.1 |
| 1 | 0 | 0 | X | | X |
| 2 | 30 | 0 | X | X | X |
| 3 | −30 | 0 | X | X | X |
| 4 | 60 | 0 | | | |
| 5 | −60 | 0 | | | |
| 6 | 90 | 0 | | | |
| 7 | −90 | 0 | | | |
| 8 | 110 | 0 | X | X | X |
| 9 | −110 | 0 | X | X | X |
| 10 | 135 | 0 | | | |
| 11 | −135 | 0 | | | |
| 12 | 180 | 0 | | | |
| 13 | 0 | 35 | | X | |
| 14 | 45 | 35 | | | |
| 15 | −45 | 35 | | | |
| 16 | 30 | 35 | | X | X |
| 17 | −30 | 35 | | X | X |
| 18 | 90 | 35 | | | |
| 19 | −90 | 35 | | | |
| 20 | 110 | 35 | | | X |
| 21 | −110 | 35 | | | X |
| 22 | 135 | 35 | | | |
| 23 | −135 | 35 | | | |
| 24 | 180 | 35 | | | |
| 25 | 0 | 90 | | | X |
| 26 | 0 | −15 | | X | |
| 27 | 45 | −15 | | | |
| 28 | −45 | −15 | | | |
| 29 (LFE1) | 45 | −15 | X | X | X |
| 30 (LFE2) | −45 | −15 | | | |

Hereinafter, a process of rendering an input signal by mapping an M-channel input signal to an N-channel output signal will be described. In other words, a process of converting an input format to an output format will be described. In each of Equations 7 through 24 shown below, a left side of an equal sign may refer to the number of channel related to an output signal based on No. of Table 2, and a right side of the equal sign may refer to a combination of a panning coefficient and the number of channel related to an input signal.

(1) Conversion of a 22.2 channel to a 5.1 channel

1=1*1+1*13+0.7*25+1*26

2=1*2+0.7*4+0.7*6+1*14+0.7*18+1*27

3=1*3+0.7*5+0.7*7+1*15+0.7*19+1*28

8=1*10+0.7*4+0.7*6+0.7*12+0.7*18+1*22+0.7*24+0.5*25

9=1*11+0.7*5+0.7*7+0.7*12+0.7*19+1*23+0.7*24+0.5*25

29=0.7*29+0.7*30 [Equation 7]

1=1*1+1*13+0.7*25+1*26

2=1*2+0.7*4+0.7*6+1*14+0.7*18+1*27

3=1*3+0.7*5+0.7*7+1*15+0.7*19+1*28

8=1*10+0.7*4+0.7*6+0.7*12+0.7*18+1*22+0.7*24−0.5*25

9=1*11+0.7*5+0.7*7+0.7*12+0.7*19+1*23+0.7*24−0.5*25

29=0.7*29+0.7*30 [Equation 8]

(2) Conversion of a 22.2 channel to an 8.1 channel

2=1*2+0.7*1+0.7*4+0.7*6+1*27

3=1*3+0.7*1+0.7*5+0.7*7+1*28

8=1*10+0.7*4+0.7*6+0.7*12+0.7*18+1*22+0.7*24+0.5*25

9=1*11+0.7*5+0.7*7+0.7*12+0.7*19+1*23+0.7*24+0.5*25

13=1*13+0.7*25

16=1*14+0.7*18

17=1*15+0.7*19

26=1*26

29=0.7*29+0.7*30 [Equation 9]

2=1*2+0.7*1+0.7*4+0.7*6+1*27

3=1*3+0.7*1+0.7*5+0.7*7+1*28

8=1*10+0.7*4+0.7*6+0.7*12+0.7*18+1*22+0.7*24−0.5*25

9=1*11+0.7*5+0.7*7+0.7*12+0.7*19+1*23+0.7*24−0.5*25

13=1*13+0.7*25

16=1*14+0.7*18

17=1*15+0.7*19

26=1*26

29=0.7*29+0.7*30 [Equation 10]

(3) Conversion of a 22.2 channel to a 10.1 channel

1=1*1+1*26

2=1*2+0.7*4+0.7*6+1*27

3=1*3+0.7*5+0.7*7+1*28

8=1*10+0.7*4+0.7*6+0.7*12

9=1*11+0.7*5+0.7*7+0.7*12

16=1*14+0.7*13+0.7*18

17=1*15+0.7*13+0.7*19

20=1*22+0.7*18+0.7*24

21=1*23+0.7*19+0.7*24

25=1*25

29=0.7*29+0.7*30 [Equation 11]

(4) Conversion of a 14.0 channel to a 5.1 channel

1=1*1+1*13+0.7*25

2=1*2+1*14+0.7*18

3=1*3+1*15+0.7*19

8=1*10+0.7*18+1*22+0.7*24+0.5*25

9=1*11+0.7*19+1*23+0.7*24+0.5*25

29=0 [Equation 12]

1=1*1+1*13+0.7*25

2=1*2+1*14+0.7*18

3=1*3+1*15+0.7*19

8=1*10+0.7*18+1*22+0.7*24−0.5*25

9=1*11+0.7*19+1*23+0.7*24−0.5*25

29=0 [Equation 13]

(5) Conversion of a 14.0 channel to an 8.1 channel

2=1*2+0.7*1

3=1*3+0.7*1

8=1*10+0.7*18+1*22+0.7*24+0.5*25

9=1*11+0.7*19+1*23+0.7*24+0.5*25

13=1*13+0.7*25

16=1*14+0.7*18

17=1*15+0.7*19

26=0

29=0 [Equation 14]

2=1*2+0.7*1

3=1*3+0.7*1

8=1*10+0.7*18+1*22+0.7*24−0.5*25

9=1*11+0.7*19+1*23+0.7*24−0.5≅

13=1*13+0.7*25

16=1*14+0.7*18

17=1*15+0.7*19

26=0

29=0 [Equation 15]

(6) Conversion of a 14.0 channel to a 10.1 channel

1=1*1

2=1*2

3=1*3

8=1*10

9=1*11

16=1*14+0.7*13+0.7*18

17=1*15+0.7*13+0.7*19

20=1*22+0.7*18+0.7*24

21=1*23+0.7*19+0.7*24

25=1*25

29=0 [Equation 16]

(7) Conversion of an 11.1 channel to a 5.1 channel

1=1*1+1*13+0.7*25

2=1*2+1*16

3=1*3+1*17

8=1*8+1*20+0.5*25

9=1*9+1*21+0.5*25

29=1*29 [Equation 17]

1=1*1+1*13+0.7*25

2=1*2+1*16

3=1*3+1*17

8=1*8+1*20−0.5*25

9=1*9+1*21−0.5*25

29=1*29 [Equation 18]

(8) Conversion of an 11.1 channel to an 8.1 channel

2=1*2+0.7*1

3=1*3+0.7*1

8=1*8+1*20+0.5*25

9=1*9+1*21+0.5*25

13=1*13+0.7*25

16=1*16

17=1*17

26=0

29=1*29 [Equation 19]

2=1*2+0.7*1

3=1*3+0.7*1

8=1*8+1*20−0.5*25

9=1*9+1*21−0.5*25

13=1*13+0.7*25

16=1*16

17=1*17

26=0

29=1*29 [Equation 20]

(9) Conversion of an 11.1 channel to a 10.1 channel

1=1*1

2=1*2

3=1*3

8=1*8

9=1*9

16=1*16+0.707*13

17=1*17+0.707*13

20=1*20

21=1*21

25=1*25

29=1*29 [Equation 21]

(10) Conversion of a 9.0 channel to a 5.1 channel

1=1*1

2=1*2+1*16

3=1*3+1*17

8=1*8+1*20

9=1*9+1*21

29=0 [Equation 22]

(11) Conversion of a 9.0 channel to an 8.1 channel

2=1*2+0.7*1

3=1*3+0.7*1

8=1*8+1*20

9=1*9+1*21

13=0

16=1*16

17=1*17

26=0

29=0 [Equation 23]

(12) Conversion of a 9.0 channel to a 10.1 channel

1=1*1

2=1*2

3=1*3

8=1*8

9=1*9

16=1*16

17=1*17

20=1*20

21=1*21

25=0

29=0 [Equation 24]

The virtual sound image localization method of FIG. 2 may be applicable to a time domain, a frequency domain used for Fast Fourier transform (FFT), or a sub-band domain used in conversion using a quadrature mirror filter (QMF), a hybrid filter, and the like. Additionally, different coefficients may be applied for each region based on a frequency band of an input signal, and the like, despite the same mapping relationship between an input signal and an output signal.

FIG. 3 illustrates another example of a virtual sound image localization method according to an embodiment.

In operation 301, the loudspeaker renderer 102 may determine whether determining of a panning coefficient based on one or two loudspeakers on a plane is possible. For example, when the determining of the panning coefficient is determined to be possible, the loudspeaker renderer 102 may determine a panning coefficient for a virtual sound source, based on a horizontal angle between the two loudspeakers in operation 304. In other words, the panning coefficient may be determined so that panning of the two loudspeakers may be performed.

The panning coefficient may be determined based on Equation 25 shown below.

$${θ}_{m} = \frac{{θ}_{pan} - {θ}_{1}}{{θ}_{2} - {θ}_{1}} \times 90 ° ( {cos}^{2} {θ}_{m} + {sin}^{2} {θ}_{m} = 1 ) \qquad [ Equation 25 ]$$

In Equation 25, θ₁ denotes an angle between a right loudspeaker and a base line facing a front side of a listener, and an angle between a left loudspeaker and the base line may be represented by “360−θ0₂.” Additionally, θₚₐₙ denotes an angle between a virtual sound source and the base line. θₘ denotes a gain value applied to the left loudspeaker and the right loudspeaker, and may be expressed as cos θₘ and sin θₘ. A sum of the square of cos θₘ and the square of sin θₘ is “1,” which may indicate a sum of power assigned to the left loudspeaker and power assigned to the right loudspeaker may be constant at all times.

When the determining of the panning coefficient is determined to be impossible in operation 301, the loudspeaker renderer 102 may determine whether determining of the panning coefficient based on three loudspeakers on the plane is possible in operation 302. For example, when the determining of the panning coefficient is determined to be possible in operation 302, the loudspeaker renderer 102 may determine a panning coefficient for a virtual sound source, based on a horizontal angle between the three loudspeakers in operation 304. In other words, a panning coefficient may be determined so that panning of the three loudspeakers may be performed.

When the determining of the panning coefficient is determined to be impossible in operation 302, the loudspeaker renderer 102 may determine a panning coefficient for a virtual sound source, based on a vertical angle in operation 303. For example, in operation 303, a virtual sound source may be located in a plane in which two or three loudspeakers exist. In this example, the loudspeaker renderer 102 may select a loudspeaker located closest to a location of the virtual sound source, and may determine a panning coefficient for a virtual sound source in a location based on an equal vertical angle between the two or three loudspeakers.

Hereinafter, a process of converting a format of an input signal with multiple channels will be described based on the virtual sound image localization method of FIG. 3. In other words, the process of converting a format of an input signal may refer to a process of rendering the input signal by mapping the input signal to an output signal. The above rendering process in FIG. 3 may be determined to be identical to that described in FIG. 2 with reference to Equations 1 through 6.

When the M-channel input signal is assumed to correspond to a 22.2 channel, a 14.0 channel, an 11.1 channel, and a 9.0 channel, only a channel indicated by X may be actually included based on a format of each channel, as shown in Table 1.

Additionally, when the N channel output signal is assumed to correspond to a 5.1 channel, and a 10.1 channel, only a channel indicated by X may be actually included based on a format of each channel, as shown in Table 3 below.

TABLE 3

| | | |
|---|---|---|
| | | Output |
| | | channel |
| Horizontal | Vertical | format |

| No. | angle° | angle° | 5.1 | 10.1 |
|---|---|---|---|---|
| 1 | 0 | 0 | | |
| 2 | 30 | 0 | | |
| 3 | −30 | 0 | X | X |
| 4 | 60 | 0 | | |
| 5 | −60 | 0 | | |
| 6 | 90 | 0 | | |
| 7 | −90 | 0 | | X |
| 8 | 110 | 0 | | X |
| 9 | −110 | 0 | X | |
| 10 | 135 | 0 | | |
| 11 | −135 | 0 | | |
| 12 | 180 | 0 | | |
| 13 | 0 | 35 | | |
| 14 | 45 | 35 | X | |
| 15 | −45 | 35 | | X |
| 16 | 30 | 35 | | X |
| 17 | −30 | 35 | | |
| 18 | 90 | 35 | | |
| 19 | −90 | 35 | | |
| 20 | 110 | 35 | | |
| 21 | −110 | 35 | | X |
| 22 | 135 | 35 | X | X |
| 23 | −135 | 35 | | |
| 24 | 180 | 35 | | |
| 25 | 0 | 90 | | X |
| 26 | 0 | −15 | X | X |
| 27 | 45 | −15 | | X |
| 28 | −45 | −15 | | |
| 29 (LFE1) | | | X | X |
| 30 (LFE2) | | | | |

Hereinafter, a process of rendering an input signal by mapping an M-channel input signal to an N-channel output signal will be described. In other words, a process of converting an input format to an output format will be described. In each of Equations 26 through 33 shown below, a left side of an equal sign may refer to the number of channel related to an output signal based on No. of Table 2, and a right side of the equal sign may refer to a combination of a panning coefficient and the number of channel related to an input signal.

(1) Conversion of a 22.2 channel to a 5.1 channel

3=0.43*1+1*3+0.84*5+0.37*7+0.82*13+0.96*15+0.37*19+0.96*28

9=0.55*5+0.93*7+0.92*11+0.60*12+0.27*15+0.93*19+0.92*23+0.60*24+0.42*25+0.27*28

14=0.37*1+0.89*2+0.97*4+0.71*6+0.58*13+1*14+0.71*18+1*27

22=0.25*4+0.71*6+1*10+0.39*11+0.80*12+0.71*18+1*22+0.39*23+0.80*24+0.57*25

26=0.82*1+0.46*2+0.71*25+1*26

29=0.707*29+0.707*30 [Equation 26]

(2) Conversion of a 22.2 channel to a 10.1 channel

3=0.32*1+1*3+0.71*5+0.94*28

7=0.71*5+1*7+0.34*28

8=0.46*4+0.94*6

15=0.58*13+1*15+0.44*19

16=0.39*1+0.52*2+0.37*4+0.14*6+0.82*13+0.97*14+0.63*18

21=0.92*11+0.60*12+0.90*19+0.92*23+0.60*24

22=1*10+0.39*11+0.80*12+0.25*14+0.77*18+1*22+0.39*23+0.80*24

25=1*25

26=0.86*1+0.39*2+1*26

27=0.76*2+0.81*4+0.32*6+1*27

29=0.707*29+0.707*30 [Equation 27]

(3) Conversion of a 14.0 channel to a 5.1 channel

3=0.43*1+1*3+0.82*13+0.96*15+0.37*19

9=0.92*11+0.27*15+0.93*19+0.92*23+0.60*24+0.42*25

14=0.37*1+0.89*2+0.58*13+1*14+0.71*18

22=1*10+0.39*11+0.71*18+1*22+0.39*23+0.80*24+0.57*25

26=0.82*1+0.46*2+0.71*25

29=0 [Equation 28]

(4) Conversion of a 14.0 channel to a 10.1 channel

3=0.32*1+1*3

7=0

8=0

15=0.58*13+1*15+0.44*19

16=0.39*1+0.52*2+0.82*13+0.97*14+0.63*18

21=0.92*11+0.90*19+0.92*23+0.60*24

22=1*10+0.39*11+0.25*14+0.77*18+1*22+0.39*23+0.80*24

25=1*25

26=0.86*1+0.39*2

27=0.76*2

29=0 [Equation 29]

(5) Conversion of an 11.1 channel to a 5.1 channel

3=0.43*1+1*3+0.82*13+1*17

9=1*9+1*21+0.42*25

14=0.37*1+0.89*2+0.42*8+0.58*13+0.89*16+0.42*20

22=0.91*8+0.91*20+0.57*25

26=0.82*1+0.46*2+0.46*16+0.71*25

29=1*29 [Equation 30]

(6) Conversion of an 11.1 channel to a 10.1 channel

3=0.32*1+1*3

7=0

8=1*8

15=0.58*13+0.96*17

16=0.39*1+0.52*2+0.82*13+1*16+0.29*17+0.39*20

21=1*9+1*21

22=0.92*20

25=1*25

26=0.86*1+0.39*2

27=0.76*2

29=1*29 [Equation 31]

(7) Conversion of a 9.0 channel to a 5.1 channel

3=0.43*1+1*3+1*17

9=1*9+1*21

14=0.37*1+0.89*2+0.42*8+0.89*16+0.42*20

22=0.91*8+0.91*20

26=0.82*1+0.46*2+0.46*16

29=0 [Equation 32]

(8)Conversion of a 9.0 channel to a 10.1 channel

3=0.32*1+1*3

7=0

8=1*8

15=0.96*17

16=0.39*1+0.52*2+1*16+0.29*17+0.39*20

21=1*9+1*21

22=0.92*20

25=0

26=0.86*1+0.39*2

27=0.76*2

29=0 [Equation 33]

In Equations 27 through 33, when a vertical angle between an input channel corresponding to an input signal and an output channel corresponding to an output signal is different from another vertical angle, for example, when an input signal corresponding to an upper channel is reproduced using a loudspeaker located on a horizontal plane, a portion of a panning coefficient may be used as a negative number. Accordingly, it is possible to more effective reproduce a virtual sound source with a vertical angle different from a vertical angle between loudspeakers.

The proposed method may be applicable to a time domain, a frequency domain based on conversion using FFT, or a sub-band domain based on conversion using a QMF, a hybrid filter, and the like. Additionally, different panning coefficients may be applied for each region based on a frequency band, and the like, despite the same connection of an input channel and an output channel.

Based on the virtual sound image localization method of FIG. 3, a panning coefficient may be determined by providing a vertical angle and a horizontal angel between loudspeakers, despite the loudspeakers not existing in a location defined by a standardized output format. Additionally, a distance variation in a distance between loudspeakers through which output signals to which an input signal is converted are reproduced may be used to determine a panning coefficient.

The above equations described in FIGS. 2 and 3 may be applied for each sample or for each frame, based on a flag. The equations may be associated with a virtual sound image localization method for reproducing a virtual sound source, and an M-channel input signal may be converted to an N-channel output signal using different methods for each sample or for each frame.

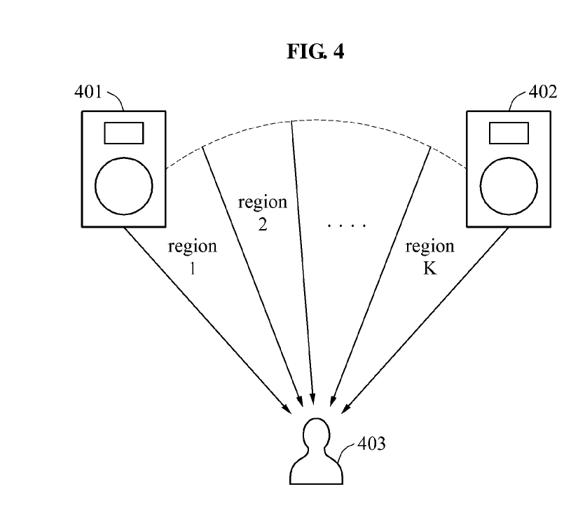

FIG. 4 illustrates an example of a space grouping-based panning scheme according to an embodiment.

Referring to FIG. 4, two loudspeakers, that is, a left loudspeaker 401 and a right loudspeaker 402 may exist. The left loudspeaker 401 and the right loudspeaker 402 may be located around a listener 403. The left loudspeaker 401 and the right loudspeaker 402 may be assumed to be located in a 2D space, for example, a line or a plane.

A reproduction region may be set based on the left loudspeaker 401 and the right loudspeaker 402 based on the listener 403. The reproduction region may be divided into K sub-regions, for example, a region 1, a region 2, and a region K. The reproduction region may be divided into the sub-regions, and a panning coefficient may be determined based on a sub-region in which a virtual sound source to be reproduced is located among the sub-regions.

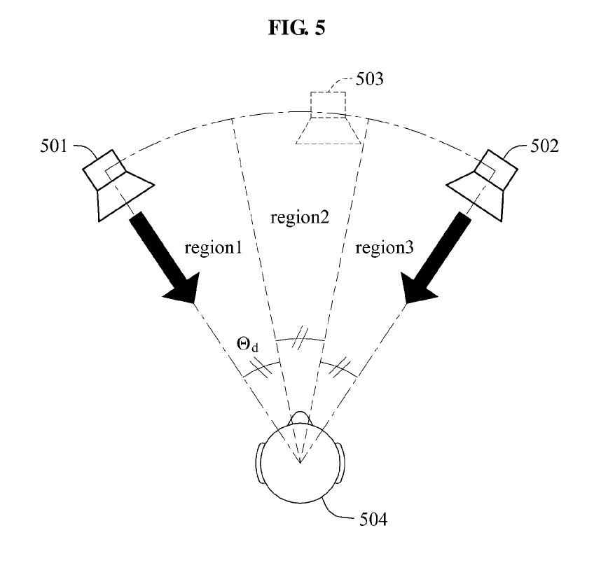

FIG. 5 illustrates the space grouping-based panning scheme of FIG. 4 in an example in which K is set to “3.”

A left loudspeaker 501 and a right loudspeaker 502 may be located around a listener 504. A virtual sound source 503 may be located on a circumference connecting the left loudspeaker 501 and the right loudspeaker 502, and may be reproduced.

The circumference may be divided based on sub-regions of a reproduction region. Referring to FIG. 5, a reproduction region including the left loudspeaker 501 and the right loudspeaker 502 may be divided into three sub-regions, and a virtual sound source may be reproduced. However, the reproduction region may not necessarily need to be equally divided.

When an angle between the left loudspeaker 501 and the right loudspeaker 502 is represented by θ, and when an angle corresponding to a sub-region is represented by θd, a panning coefficient may be determined based on a virtual sound image localization method.

In an example, when the virtual sound source 503 is reproduced on a circumference corresponding to a region 1, all power may be assigned to the left loudspeaker 501 to reproduce the virtual sound source 503. When the angles θ and θ_{d} are set to 60° and 20°, respectively, and when a virtual sound source is reproduced at an angle of 0° to 20°, the virtual sound source may be reproduced by the left loudspeaker 501 at 0°.

In another example, when the virtual sound source 503 is reproduced on a circumference corresponding to a region 2, power may be equally distributed to the left loudspeaker 501 and the right loudspeaker 502 to reproduce the virtual sound source 503. When the angles θ and θ_{d} are set to 60° and 20°, respectively, and when a virtual sound source is reproduced at an angle of 20° to 40°, power of 1/\sqrt{2} of an input signal may be distributed to the left loudspeaker 501 and the right loudspeaker 502, and the virtual sound source may be reproduced.

In still another example, when the virtual sound source 503 is reproduced on a circumference corresponding to a region 3, all power may be assigned to the right loudspeaker 502 to reproduce the virtual sound source 503. When the angles θ and θ_{d} are set to 60° and 20°, respectively, and when a virtual sound source is reproduced at an angle of 40° to 60°, the virtual sound source may be reproduced by the right loudspeaker 502 at 60°.

The reproduction region may be divided into three sub-regions, as shown in FIG. 5. However, when the reproduction region is divided into two sub-regions, a loudspeaker may be selected based on a location of a virtual sound source to be reproduced.

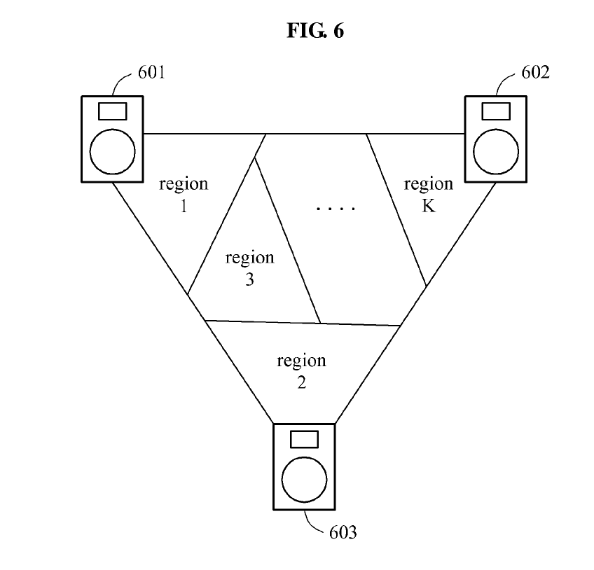

FIG. 6 illustrates another example of a space grouping-based panning scheme according to an embodiment.

FIG. 6 illustrates an example in which loudspeakers 601, 602, and 603 exist in a 3D space, unlike the example of FIG. 5. For example, at least one of the loudspeakers 601, 602, and 603 may exist in a plane, and the other may be disposed in the 3D space. In other words, in FIG. 6, loudspeakers may exist in a vertical direction (for example, upward or downward) as well as a horizontal direction in which a listener is located.

In FIG. 6, a reproduction region including the loudspeakers 601, 602, and 603 may be divided into K sub-regions. The reproduction region may be equally or nonequally divided. A panning coefficient may be determined so that power may be allocated to a loudspeaker associated with a sub-region corresponding to a location in which a virtual sound source is reproduced among the K sub-regions. The panning coefficient may have a value of “−1” to “1.”

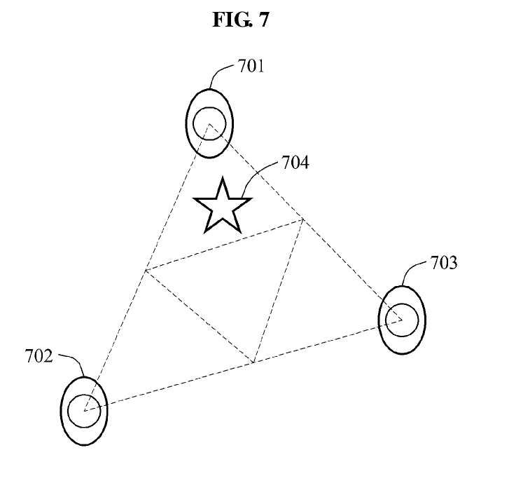

FIG. 7 illustrates the space grouping-based panning scheme of FIG. 6 in an example in which K is set to “4.”

Referring to FIG. 7, a reproduction region including loudspeakers 701, 702 and 703 in a 3D space may be divided into four sub-regions. In other words, for the loudspeakers 701, 702 and 703, the four sub-regions may be determined Accordingly, a panning coefficient for a virtual sound source to be reproduced may be determined based on a sub-region in which the virtual sound source is located among the four sub-regions.

The units described herein may be implemented using hardware components, software components, and/or a combination thereof. For example, the units and components may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A virtual sound image localization method, comprising:
determining reproduction information on at least one loudspeaker available in an output channel to reproduce a virtual sound source corresponding to an input channel; and
rendering an input signal based on the reproduction information.

2. The virtual sound image localization method of claim 1, wherein the loudspeaker exists in a two-dimensional (2D) space or three-dimensional (3D) space.

3. The virtual sound image localization method of claim 1, wherein the determining comprises:
dividing a reproduction region comprising the loudspeaker into a plurality of sub-regions;
determining a sub-region in which the virtual sound source is located among the sub-regions; and
determining a panning coefficient of the loudspeaker based on the determined sub-region.

4. The virtual sound image localization method of claim 3, wherein the dividing comprises dividing a reproduction region corresponding to a circumference connecting two loudspeakers into a plurality of sub-regions, and
wherein the determining comprises determining a sub-region in which the virtual sound source is located among the sub-regions.

5. The virtual sound image localization method of claim 3, wherein the dividing comprises dividing a reproduction region comprising K loudspeakers (K>3) into X sub-regions (X>K), and
wherein the determining comprises determining a sub-region in which the virtual sound source is located among the sub-regions.

6. A virtual sound image localization method, comprising:
setting a reproduction region comprising at least one loudspeaker available in an output channel;
dividing the reproduction region into a plurality of sub-regions;
determining a sub-region in which a virtual sound source to be reproduced is located among the sub-regions;
determining a panning coefficient used to reproduce the virtual sound source, based on the determined sub-region; and
rendering an input signal based on the panning coefficient.

7. The virtual sound image localization method of claim 6, wherein the loudspeaker exists in a two-dimensional (2D) space or three-dimensional (3D) space.

8. The virtual sound image localization method of claim 6, wherein the dividing comprises dividing a reproduction region corresponding to a circumference connecting two loudspeakers into a plurality of sub-regions, and
wherein the determining comprises determining a sub-region in which the virtual sound source is located among the sub-regions.

9. The virtual sound image localization method of claim 6, wherein the dividing comprises dividing a reproduction region comprising K loudspeakers (K>3) into X sub-regions (X>K), and
wherein the determining comprises determining a sub-region in which the virtual sound source is located among the sub-regions.

10. A virtual sound image localization method, comprising:
determining whether determining of a panning coefficient for a virtual sound source based on loudspeakers located on a plane is possible; and
determining the panning coefficient based on a result of the determining.

11. The virtual sound image localization method of claim 10, wherein the determining of the panning coefficient comprises, when the determining of the panning coefficient based on the loudspeaker on the plane is possible, determining the panning coefficient based on a horizontal angle.

12. The virtual sound image localization method of claim 10, wherein the determining of the panning coefficient comprises, when the determining of the panning coefficient based on the loudspeaker on the plane is impossible, determining the panning coefficient based on a vertical angle.

13. A virtual sound image localization method, comprising:
determining whether loudspeakers are located in a two-dimensional (2D) space or three-dimensional (3D) space; and
determining a panning coefficient for a virtual sound source, based on a result of the determining.

14. The virtual sound image localization method of claim 13, wherein the determining of the panning coefficient comprises, when the loudspeakers are located in the 2D space, determining the panning coefficient based on a horizontal angle.

15. The virtual sound image localization method of claim 13, wherein the determining of the panning coefficient comprises, when the loudspeakers are located in the 3D space, determining the panning coefficient based on a vertical angle.
